(19) United States
(12) Patent Application Publication
(10) Pub. No.: US 2023/0387542 A1
(43) Pub. Date: Nov. 30, 2023

(54) SEALED BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Tsuyoshi EHARA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/303,572

(22) Filed: Apr. 20, 2023

(30) Foreign Application Priority Data
May 26, 2022 (JP) 2022-086250

(51) Int. Cl. H01M 50/342; H01M 50/103

(52) U.S. Cl. CPC H01M 50/3425; H01M 50/103

(57) ABSTRACT

In a sealed battery, a battery case includes a metal wall portion formed with a gas vent hole. The metal wall portion includes an annular seal surface surrounding an opening edge of the gas vent hole. A resin safety valve member closing the gas vent hole includes an annular joined portion hermetically joined to the annular seal surface and an inside portion located more inside than the annular joined portion in a radial direction. The inside portion breaks when the internal pressure of the battery case reaches a valve opening pressure, thereby opening the resin safety valve member.

### CROSS-REFERENCE TO RELATED APPLICATIONS

This application is based upon and claims the benefit of priority to a Japanese Patent Application No. 2022-086250 filed on May 26, 2022, the entire contents of which are incorporated herein by reference.

### BACKGROUND

### Technical Field

The present disclosure relates to a sealed battery.

### Related Art

Japanese unexamined patent application publication No. 2018-041668 discloses a sealed battery including an electrode body, and a metal battery case accommodating the electrode body. The battery case is provided with a rectangular box-shaped case body having an opening, and a metal lid member closing the opening of the case body. The case body and the lid member are integrated together by welding, constituting the battery case. The lid member is provided, at its center, with a safety valve. This safety valve is integrated with the lid member.

The safety valve is thinner than other portions of the lid member and formed with a groove portion on the top surface. Thus, the safety valve actuates when the internal pressure of the battery case reaches a predetermined pressure (i.e., a pressure at which the safety valve opens, hereinafter referred to as a valve opening pressure). Specifically, when the internal pressure of the battery case reaches the valve opening pressure, the groove portion ruptures to open the safety valve, thus releasing gas out of the battery case. This configuration can prevent the internal pressure of the battery case from excessively rising, i.e., from reaching a dangerous internal pressure.

### SUMMARY

### Technical Problems

Meanwhile, the foregoing safety valve is integrated together with the lid member made of aluminum. To be concrete, the safety valve is formed in the lid member at the same time of press-molding the lid member from an aluminum plate. However, a method for forming a safety valve in a lid member by the press-molding has limitations on the thickness and the material of a metal plate to be molded into the lid member. This method is therefore difficult to address a wide variety of sealed batteries.

From those circumstances, it has been required to make a safety valve from a different member from a metal wall portion, such as a lid member, that makes up a battery case. Specifically, it has been required that the battery case is formed as a battery case having a metal wall portion formed with a gas vent hole, the safety valve is formed as a safety valve member that closes the gas vent hole. Furthermore, a safety valve member made of resin is demanded for easy production. In other words, a sealed battery has been required in which the gas vent hole formed in the metal wall portion of the battery case is sealed with-a resin safety valve member made of resin, and this resin safety valve member opens when the internal pressure of the battery case reaches the valve opening pressure.

The present disclosure has been made to address the above problems and has a purpose to provide a sealed battery in which a gas vent hole formed in a metal wall portion of a battery case is sealed with a resin safety valve member made of resin, which can open when the internal pressure of the battery case reaches a valve opening pressure.

### Means of Solving the Problems

(1) To achieve the above-mentioned purpose, one aspect of the present disclosure provides a sealed battery comprising: a battery case including a metal wall portion formed with a gas vent hole; and a safety valve member closing the gas vent hole, wherein the safety valve member is a resin safety valve member made of resin, the metal wall portion includes an annular seal surface that surrounds an opening edge of the gas vent hole, the resin safety valve member includes: an annular joined portion hermetically joined to the annular seal surface; and an inside portion located more inside than the annular joined portion in a radial direction, and the inside portion is configured to break when an internal pressure of the battery case reaches a valve opening pressure to open the resin safety valve member.

The above-described sealed battery includes the safety valve member, which closes the gas vent hole formed in the metal lid of the battery case. The safety valve member is a resin safety valve member made of resin. This resin safety valve member includes the annular joined portion hermetically joined to the annular seal surface, which is a part of the metal wall portion and surrounds the opening edge of the gas vent hole. With this annular joined portion, the resin safety valve member is hermetically joined to the metal wall portion, and hence the gas vent hole is sealed with the resin safety valve member.

In this sealed battery, moreover, when the internal pressure of the battery case reaches the valve opening pressure, the inside portion of the resin safety valve member (i.e., the portion located more inside than the annular joined portion in the radial direction) breaks, or ruptures, thus opening the resin safety valve member, that is, releasing the sealing of the gas vent hole sealed with the resin safety valve member. To be concrete, when the internal pressure of the battery case reaches the valve opening pressure, the stress caused in the inside portion of the resin safety valve member by the internal pressure of the battery case reaches a breaking strength of the inside portion, thereby breaking, e.g., rupturing, the inside portion and thus releasing the gas vent hole from sealing by the resin safety valve member. Accordingly, the inside of the battery case is maintained hermetic with the annular joined portion of the resin safety valve member hermetically joined to the annular seal surface of the metal wall portion, whereas once the internal pressure of the battery case reaches the valve opening pressure, the resin safety valve member opens, releasing the gas out of the battery case to prevent the internal pressure of the battery case from excessively rising. As described above, the foregoing sealed battery is a sealed battery in which

the gas vent hole formed in the metal wall portion of the battery case is sealed with the resin safety valve member made of resin and further the resin safety valve member opens when the internal pressure of the battery case reaches the valve opening pressure.

(2) In the sealed battery described in (1), furthermore, the annular seal surface is an annular roughened surface having an uneven shape with pits and protrusions, and the resin safety valve member is hermetically joined to the annular roughened surface by the annular joined portion made of part of the resin forming the safety valve member, the part of the resin forming the annular joined portion entering into the pits of the annular roughened surface.

In the foregoing sealed battery, the annular joined portion of the resin safety valve member is hermetically joined to the annular roughened surface having an uneven shape with pits and protrusions by entering or penetrating of the resin that forms the annular joined portion into the pits of the annular roughened surface of the metal wall portion. In other words, the annular joined portion of the resin safety valve member is hermetically joined to the annular roughened surface by the anchor effect exerted by biting of the protrusions of the annular roughened surface of the metal wall portion into the annular joined portion of the resin safety valve member. This can enhance the hermeticity between the annular joined portion of the resin safety valve member and the annular roughened surface of the metal wall portion and hence increase the hermeticity of the sealed battery.

(3) In the sealed battery described in (1) or (2), furthermore, the inside portion includes a thinnest portion, which is a part of the inside portion and has a thinnest thickness in the inside portion, and the thinnest portion breaks when the internal pressure of the battery case reaches the valve opening pressure to open the resin safety valve member.

In the foregoing sealed battery, the inside portion of the resin safety valve member is not constant in thickness, i.e., wall thickness and includes the thinnest portion with a smallest thickness in the inside portion. Therefore, the valve opening position, where the inside portion is to break when the internal pressure of the battery case reaches the valve opening pressure, can be set at that thinnest portion. This configuration can set the valve opening pressure with high accuracy. The thus configured sealed battery is a sealed battery with accurately set valve opening pressure.

(4) In the sealed battery described in (3), furthermore, the valve opening pressure is determined by a thickness of the thinnest portion.

Since the inside portion of the resin safety valve member includes the thinnest portion, this thinnest portion can be determined as a valve opening position, where the inside portion is to break when the internal pressure of the battery case reaches the valve opening pressure. Further, adjusting the thickness of the thinnest portion enables control of the valve opening pressure. This is because the breaking strength of the thinnest portion depends on the thickness of the thinnest portion. Hence, the valve opening pressure of the above-described sealed battery is determined by the thickness of the thinnest portion. Since the valve opening pressure thus is determined by the thickness of the thinnest portion, the valve opening pressure can be set with high accuracy. This sealed battery is a sealed battery with an accurately set valve opening pressure.

(5) In the sealed battery described in (3) or (4), the inside portion may include a groove, and the thinnest portion may be a bottom of the groove.

Since the inside portion of the resin safety valve member is provided with the groove as the thinnest portion, the valve opening position, where the inside portion is to break when the internal pressure of the battery case reaches the valve opening pressure, can be set at the bottom of the groove. This configuration can set the valve opening pressure with high accuracy. The thus configured sealed battery is a sealed battery with accurately set valve opening pressure.

(6) In the sealed battery described in (5), the groove may be located in a position where the central axis of the annular joined portion passes through the bottom of the groove.

Since the groove is provided so that the central axis of the annular joined portion passes through the bottom of the groove, the internal pressure of the battery case, that is, the valve opening pressure, when the bottom of the groove is to break can be set with high accuracy. Therefore, this sealed battery is a sealed battery with an accurately set valve opening pressure.

### BRIEF DESCRIPTION OF THE DRAWINGS

FIG. 1 is a plan view, i.e., a top view, of a sealed battery in an embodiment;

FIG. 2 is a front view of the sealed battery;

FIG. 3 is a cross-sectional view taken along B-B in FIG. 1;

FIG. 4 is an enlarged view of a section C in FIG. 3;

FIG. 5 is a plan view of a safety valve-equipped lid, i.e., an insert molded product;

FIG. 6 is a cross-sectional view taken along D-D in FIG. 5;

FIG. 7 is a plan view of a metal lid;

FIG. 8 is a cross-sectional view taken along E-E in FIG. 7; and

FIG. 9 is an enlarged view of a section F in FIG. 8.

### DETAILED DESCRIPTION OF THE EXEMPLARY EMBODIMENTS

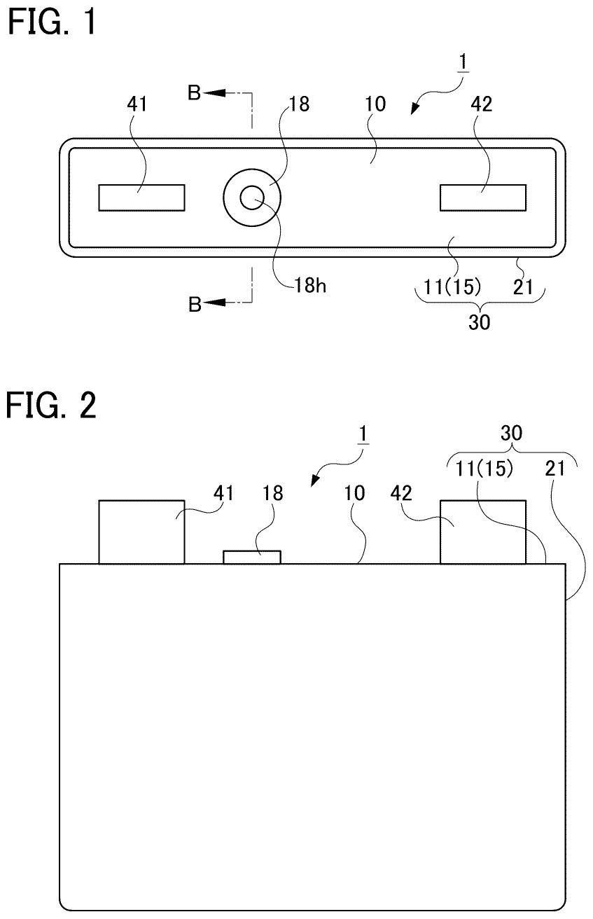

A detailed description of an embodiment of this disclosure will now be given referring to the accompanying drawings. A sealed battery 1 in the present embodiment is a lithium-ion secondary battery and includes a battery case 30, an electrode body 50 accommodated in the battery case 30, a positive terminal 41, and a negative terminal 42 (see FIGS. 1 to 3). The battery case 30 is a hard case made of metal and has a rectangular parallelepiped box-like shape. This battery case 30 includes a metal case body 21 having a rectangular tubular shape with a closed bottom, and a metal lid 11 having a rectangular flat plate shape and closing an opening 21b of the case body 21 (see FIGS. 1 to 3). The metal lid 11 includes a metal wall portion 15 formed with a gas vent hole 12. This metal wall portion 15 is a part of the metal lid 11.

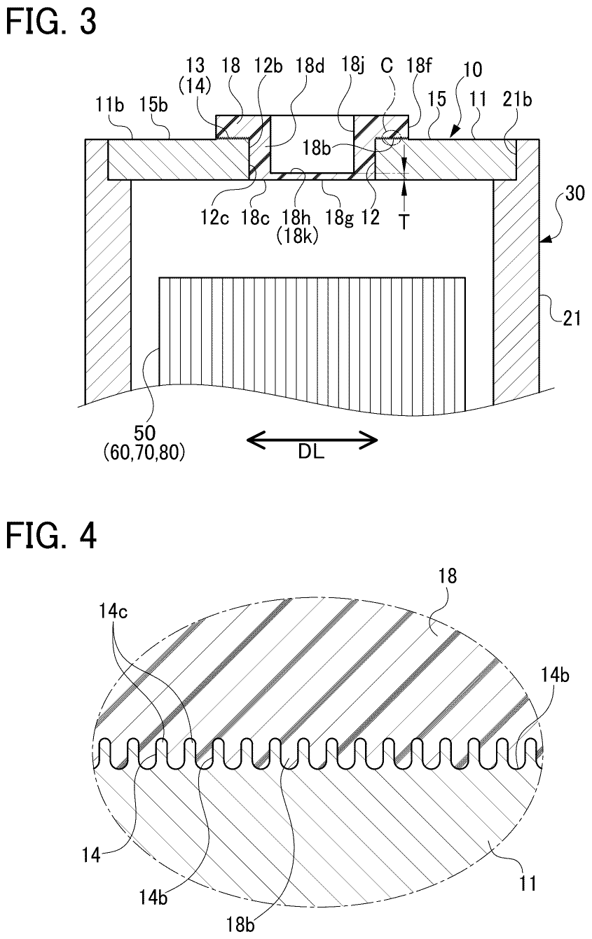

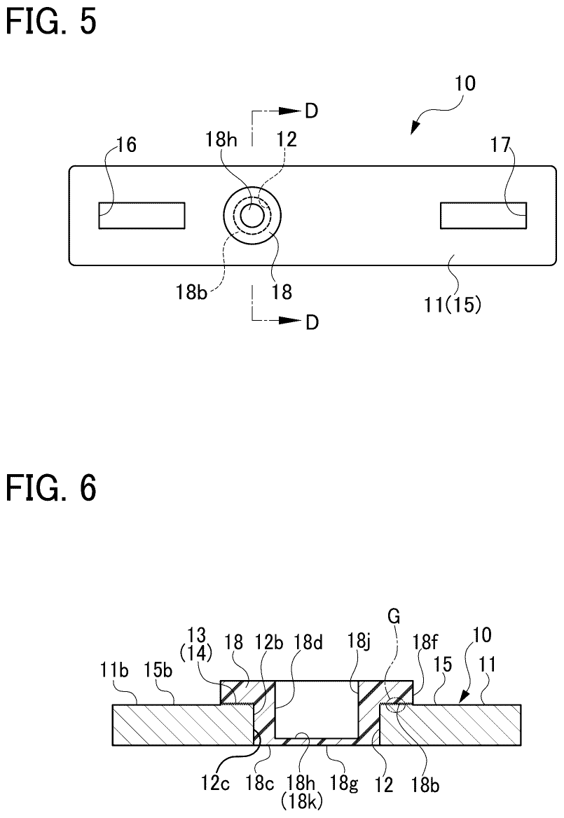

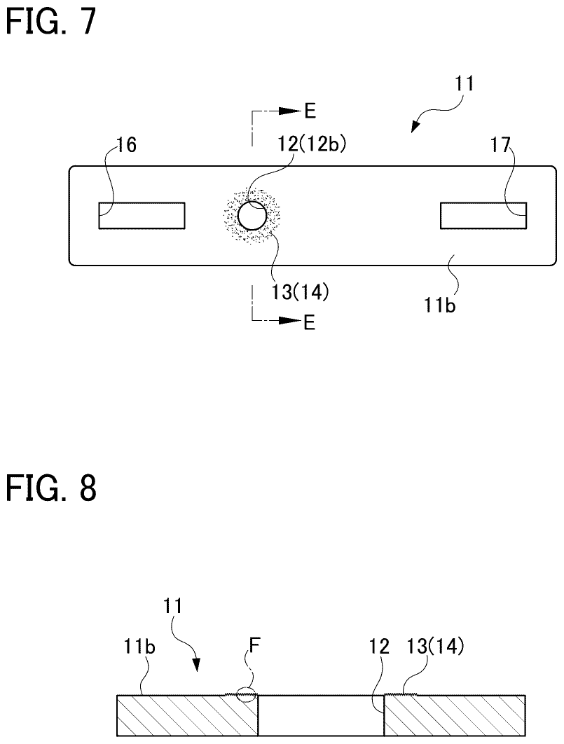

The metal lid 11 has two through holes 16 and 17 each having a rectangular tubular shape as shown in FIGS. 5 and 7. The positive terminal 41 is inserted through the through hole 16, while the negative terminal 42 is inserted through the through hole 17, as shown in FIGS. 1 and 2. In addition, a tubular insulation member (not shown) is interposed between the inner peripheral surface of the through hole 16 of the metal lid 11 and the outer peripheral surface of the positive terminal 41 and another tubular insulation member (not shown) is interposed between the inner peripheral surface of the through hole 17 of the metal lid 11 and the outer peripheral surface of the negative terminal 42. The metal lid 11, concretely, the metal wall portion 15, is formed with the gas vent hole 12 having a cylindrical shape penetrating through the metal lid 11 in its thickness direction as shown in FIG. 3.

The electrode body 50 includes positive electrode sheets 60, negative electrode sheets 70, and separators 80 each interposed between the positive electrode sheet 60 and the negative electrode sheet 70. More concretely, the electrode body 50 is a lamination electrode body provided with a plurality of positive electrode sheets a plurality of negative electrode sheets 70, and a plurality of separators 80, in which the positive electrode sheets 60 and the negative electrode sheets 70 are alternately laminated, or stacked, with the separators 80 each interposed therebetween in a lamination direction DL as shown in FIG. 3. The electrode body 50 further contains an electrolytic solution not shown. This electrolytic solution, not shown, is also accommodated within the battery case 30 on the bottom side. The positive electrode sheets 60 of the electrode body 50 are connected to the positive terminal 41 through a positive current collecting tab (not shown). The negative electrode sheets are connected to the negative terminal 45 through a negative current collecting tab (not shown).

The metal lid 11 (concretely, the metal wall portion 15) includes an annular seal surface 14 having a circular annular shape surrounding the opening edge 12b of the gas vent hole 12 as shown in FIGS. 7 to 9. In the present embodiment, a hole-surrounding surface 13 included in the outer surface 11b of the metal wall portion 11, concretely, the outer surface 15b of the metal wall portion 15, and formed in a circular annular shape surrounding the opening edge 12b of the gas vent hole 12 is the annular seal surface 14.

Furthermore, the sealed battery 1 is provided with a resin safety valve member 18 for closing the gas vent hole 12 of the metal lid 11 (concretely, the metal wall portion 15). This resin safety valve member 18 has a closed-bottom cylindrical shape with a flange, including an annular joined portion 18b hermetically joined to the annular seal surface 14 and an inside portion 18c located more inside than the annular joined portion 18b in a radial direction of the resin safety valve member 18, as shown in FIGS. 3 and 4. In the present embodiment, concretely, the resin safety valve member 18 consists of a cylindrical portion 18d having a closed-bottom cylindrical shape and a circular ring-shaped flange 18f protruding radially outward from the outer periphery of the cylindrical portion 18d. Thus, the cylindrical portion 18d corresponds to the inside portion 18c, and a part of the flange 18f, located adjacent to the annular seal surface 14, corresponds to the annular joined portion 18b.

The resin safety valve member 18 may be made of a resin with low permeability to an electrolytic solution, for example, polyphenylene sulfide (PPS), polyarylene sulfide (PAS), olefin resin, or fluororesin. In the present embodiment, the resin safety valve member 18 is made of PPS.

The resin safety valve member 18 includes an annular joined portion 18b hermetically joined to the annular seal surface 14 as shown in FIGS. 3 and 4. The annular joined portion 18b has a circular annular shape in plan view as shown in FIG. 7. With the annular joined portion 18b configured as above, the resin safety valve member 18 is hermetically joined to the metal lid 11, concretely, the metal wall portion and the gas vent hole 12 is sealed with the resin safety valve member 18. It is noted that the inside portion 18c (i.e., the cylindrical portion 18d) of the resin safety valve member 18 is not hermetically joined to the inner peripheral surface 12c of the gas vent hole 12, so that gas is allowed to enter between the inside portion 18c and the inner peripheral surface 12c.

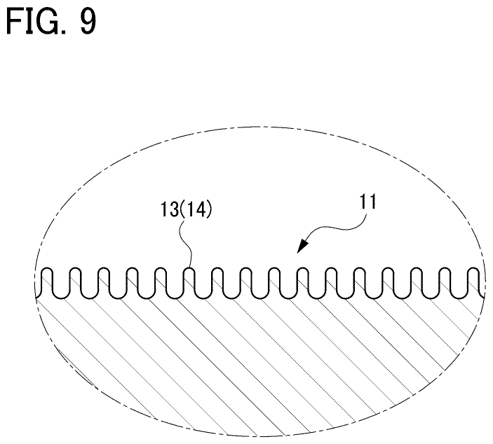

In the present embodiment, especially, the annular seal surface 14 of the metal lid 11 (concretely, of the metal wall portion 15) is an annular roughened surface 14 having an uneven shape with pits 14b and protrusions 14c as shown in FIGS. 8 and 9. This annular roughened surface 14 has a circular annular, or circular ring, shape in plan view as shown in FIG. 7. The resin safety valve member 18 is hermetically joined to the annular roughened surface 14 by the annular joined portion 18b, which is made of part of the resin forming the resin safety valve member 18, the part of the resin forming the annular joined portion entering, or penetrating, into the pits 14b of the annular roughened surface 14, as shown in FIG. 4. In other words, the annular joined portion 18b of the resin safety valve member 18 is hermetically joined to the annular roughened surface 14 by the anchor effect exerted by biting of the protrusions 14c of the annular roughened surface 14 of the metal wall portion 15 into the annular joined portion 18b of the resin safety valve member 18. This can enhance the hermeticity between the annular joined portion 18b of the resin safety valve member 18 and the annular roughened surface 14 of the metal wall portion 15, and hence increase the hermeticity of the sealed battery 1.

The annular roughened surface 14 can be formed by a well-known surface roughening treatment applied to the hole-surrounding surface 13 of the outer surface 11b of the metal lid 11. This treatment may include for example a laser surface treatment, a sandblasting treatment, and an anodizing treatment. One example of the laser surface treatment is disclosed in Japanese unexamined patent application publication No. 2022-028587. In the present embodiment, the hole-surrounding surface 13 of the metal lid 11 is roughened by the laser surface treatment to form the annular roughened surface 14.

The metal lid 11 and the resin safety valve member 18 are integrated by insert molding. Specifically, the metal lid 11 and the resin safety valve member 18 are insert-molded to form a lid 10 equipped with a safety valve, hereinafter referred to as a safety valve-equipped lid 10, which is an insert molded product including the metal lid 11 integrated with the resin safety valve member 18 as shown in FIGS. 5 and 6. This safety valve-equipped lid 10 is produced as below. Specifically, the metal lid 11 with the annular roughened surface 14 (see FIGS. 7 to 9) is prepared first. Subsequently, with this metal lid 11 set as an insert member, the resin safety valve member 18 is made of resin by injection molding. The safety valve-equipped lid 10 is thus produced as the insert molded product in which the metal lid 11 and the resin safety valve member 18 are integrated together, as shown in FIGS. 5 and 6.

By use of the safety valve-equipped lid 10 including the metal lid 11 and the resin safety valve member 18 integrated together by insert molding, the sealed battery 1 can be easily and appropriately manufactured with the gas vent hole 12 of the metal lid 11 sealed with the resin safety valve member 18. It is noted that a part of the resin injected to mold the resin safety valve member 18, that is, a resin forming the annular joined portion 18b, enters into the pits 14b of the annular roughened surface 14 of the metal lid 11, so that the annular joined portion 18b of the resin safety valve member 18 is hermetically joined to the annular roughened surface 14 of the metal lid 11 shown in FIG. 4.

In the sealed battery 1, moreover, when the internal pressure of the battery case 30 reaches the valve opening pressure, the inside portion 18c of the resin safety valve member 18 breaks, e.g., cleaves, to open the resin safety valve member 18. More specifically, when the internal pressure of the battery case 30 rises due to the generation of gas in the battery case 30, the force that pushes upward a lower surface 18g of the resin safety valve member 18 (concretely, the lower surface 18g of the inside portion 18c) becomes larger, and thus the stress occurring in the inside portion 18c becomes larger (see FIG. 3). When the internal pressure of the battery case 30 then reaches the valve opening pressure, the stress generated in the inside portion 18c reaches the breaking strength of the inside portion 18c. At this time, the inside portion 18c breaks, e.g., ruptures, forming a venting hole in the inside portion 18c, that is, opening the resin safety valve member 18, so that the gas vent hole 12 is released from sealing. This gas vent hole 12 (concretely, the venting hole formed in the inside portion 18c) allows the gas to escape from the inside to the outside of the battery case thereby preventing an excessive rise of the internal pressure of the battery case 30.

In the sealed battery 1, specifically, the inside portion 18c of the resin safety valve member 18 is not constant thickness, or wall thickness, and a part of the inside portion 18c, that is, a second portion 18k, is formed as a thinnest portion 18h having a smallest thickness in the inside portion 18c. The inside portion 18c consists of a first portion 18j of a cylindrical shape extending in the thickness direction of the metal lid 11, i.e., in a vertical direction in FIG. 3, and the second portion 18k of a circular disk shape located more inside than the inner peripheral surface of the first portion 18j in the radial direction. Since the inside portion 18c of the resin safety valve member 18 has a non-constant thickness, or wall thickness, and includes the thinnest portion 18h, the valve opening position, where the inside portion 18c is to break when the internal pressure of the battery case 30 reaches the valve opening pressure, can be set at the thinnest portion 18h. In the sealed battery 1, therefore, when the internal pressure of the battery case 30 reaches the valve opening pressure, the stress occurring in the thinnest portion 18h reaches the breaking strength of the thinnest portion 18h and thus the thinnest portion 18h is broken, or raptured, opening the resin safety valve member 18, that is, releasing the sealing of the gas vent hole 12.

Since the valve opening position where the inside portion 18c is to break when the internal pressure of the battery case 30 reaches the valve opening pressure is determined to the thinnest portion 18h, which is a part of the inside portion 18c, the valve opening pressure can be set with high accuracy. The sealed battery 1 is thus a sealed battery with the accurately set valve opening pressure.

As described above, the sealed battery 1 in the present embodiment is configured such that the annular joined portion 18b of the resin safety valve member 18 is hermetically joined to the annular seal surface 14 of the metal lid 11 (concretely, of the metal wall portion 15) to maintain the hermeticity of the battery case 30, whereas once the internal pressure of the battery case 30 reaches the valve opening pressure, the resin safety valve member 18 opens to release the gas out of the battery case 30 in order to prevent the internal pressure of the battery case 30 from excessively rising. Thus, the sealed battery 1 is achieved as a sealed battery in which the gas vent hole 12 of the metal wall portion 15 of the battery case 30 is sealed with the resin safety valve member 18 made of resin, and further the resin safety valve member 18 opens when the internal pressure of the battery case 30 reaches the valve opening pressure.

Meanwhile, the valve opening pressure of the resin safety valve member 18 can be controlled by adjusting the thickness of the thinnest portion 18h of the resin safety valve member 18, i.e., the thickness of the valve opening position of the resin safety valve member 18. This is because the breaking strength of the thinnest portion 18h is different depending on the thickness of the thinnest portion 18h. The valve opening pressure of the resin safety valve member 18 corresponds to the internal pressure of the battery case 30 at which the thinnest portion 18h of the resin safety valve member 18 breaks to release the sealing of the gas vent hole 12.

In the sealed battery 1 in the present embodiment, in this respect, the valve opening pressure of the resin safety valve member 18 is determined by the thickness T of the thinnest portion 18h. Since the valve opening pressure is thus set by the thickness T of the thinnest portion 18h, the valve opening pressure can be accurately set. Consequently, the sealed battery 1 is a sealed battery with the accurately set valve opening pressure.

TABLE 1

| Thickness T of Thinnest portion (mm) | Valve opening pressure (MPa) |
|---|---|
| 0.06 | 1.4 |
| 0.10 | 2.0 |
| 0.15 | 2.7 |

Table 1 shows the correspondence relationship between the thickness T (mm) of the thinnest portion 18h and the valve opening pressure (MPa). For example, as shown in Table 1, for a sealed battery 1 with the thinnest portion 18h having a thickness T of 0.06 mm, the valve opening pressure can be set to 1.4 MPa. For another sealed battery 1 with the thinnest portion 18h having a thickness T of 0.10 mm, the valve opening pressure can be set to 2.0 MPa. For another sealed battery 1 with the thinnest portion 18h having a thickness T of 0.15 mm, the valve opening pressure can be set to 2.7 MPa. In this way, the valve opening pressure of the resin safety valve member 18 can be determined by the thickness T of the thinnest portion 18h of the resin safety valve member 18.

The present disclosure is described in the above embodiment, but is not limited thereto. It should be understood that the present disclosure may be embodied in other specific forms without departing from the essential characteristics thereof.

For example, the above-described embodiment adopts the safety valve-equipped lid 10 provided with the metal lid 11 and the resin safety valve member 18 integrated together by insert molding. However, the safety valve-equipped lid 10 may be a safety valve-equipped lid provided with the metal lid 11 and a resin safety valve member made of a resin film welded to the metal lid 11. This safety valve-equipped lid can be produced as below. Specifically, the metal lid 11 with the annular roughened surface 14 (see FIGS. 7 to 9) is prepared first. The resin safety valve member formed of a resin film is further prepared. This resin film may be configured such that the thickness is not constant, and a portion which will form the inside portion is thinner than the other portion that is located around this portion, i.e., than a portion which will form an annular joined portion. Then, the metal lid 11 is heated to 200° C. and further a part of the surface of the resin safety valve member, which will contact with the annular roughened surface 14, is heated to soften or fuse, and finally the resin safety valve member is welded to the annular roughened surface 14 of the metal lid 11. At that time, a part of the resin that forms the resin safety valve member, i.e., the resin that forms the annular joined portion, enters into the pits 14b of the annular roughened surface 14 of the metal lid 11, enabling hermetic joining between the annular joined portion of the resin safety valve member and the annular roughened surface 14 of the metal lid 11.

The second portion 18k of the inside portion 18c of the resin safety valve member 18 may be formed with a groove so that the bottom of this groove is a thinnest portion. Therefore, the bottom of the groove can be determined as the valve opening position where the inside portion 18c is to break when the internal pressure of the battery case 30 reaches the valve opening pressure. Accordingly, the valve opening pressure can be set accurately.

The groove may be formed at a position where the central axis of the annular joined portion 18b, which coincides with the central axis of the gas vent hole 12, passes through the bottom of the groove. In other words, the groove may be formed so that its bottom extends intersecting with the central axis of the annular joined portion. This configuration enables accurate setting of the internal pressure of the battery case when the bottom of the groove is to break, that is, the valve opening pressure.

The above-described embodiment exemplifies the sealed battery 1 in which the gas vent hole 12 is formed in the metal wall portion 15 of the metal lid 11 and closed with the resin safety valve member 18. As an alternative, however, the present disclosure includes a sealed battery in which a gas vent hole is formed in a metal wall portion of the case body 21 and closed with a resin safety valve member.

### REFERENCE SIGNS LIST

1 Sealed battery
11 Metal lid
11b Outer surface of metal lid
12 Gas vent hole
12b Opening edge (of gas vent hole)
13 Hole-surrounding surface
14 Annular roughened surface (Annular seal surface)
14b Pit
15 Metal wall portion
15b Outer surface (of metal wall portion)
18 Resin safety valve member (Safety valve member)
18b Annular joined portion
18c Inside portion
18h Thinnest portion
21 Case body
30 Battery case

What is claimed is:

1. A sealed battery comprising:
a battery case including a metal wall portion formed with a gas vent hole; and
a safety valve member closing the gas vent hole,
wherein
the safety valve member is a resin safety valve member made of resin,
the metal wall portion includes an annular seal surface that surrounds an opening edge of the gas vent hole,
the resin safety valve member includes:
an annular joined portion hermetically joined to the annular seal surface; and
an inside portion located more inside than the annular joined portion in a radial direction, and
the inside portion is configured to break when an internal pressure of the battery case reaches a valve opening pressure to open the resin safety valve member.

2. The sealed battery according to claim 1, wherein
the annular seal surface is an annular roughened surface having an uneven shape with pits and protrusions, and
the resin safety valve member is hermetically joined to the annular roughened surface by the annular joined portion made of part of the resin forming the safety valve member, the part of the resin forming the annular joined portion entering into the pits of the annular roughened surface.

3. The sealed battery according to claim 1, wherein
the inside portion includes a thinnest portion, which is a part of the inside portion and has a thinnest thickness in the inside portion, and
the thinnest portion breaks when the internal pressure of the battery case reaches the valve opening pressure to open the resin safety valve member.

4. The sealed battery according to claim 2, wherein
the inside portion includes a thinnest portion, which is a part of the inside portion and has a thinnest thickness in the inside portion, and
the thinnest portion breaks when the internal pressure of the battery case reaches the valve opening pressure to open the resin safety valve member.

5. The sealed battery according to claim 3, wherein the valve opening pressure is determined by a thickness of the thinnest portion.

6. The sealed battery according to claim 4, wherein the valve opening pressure is determined by a thickness of the thinnest portion.
